(19) United States
(12) Patent Application Publication
(10) Pub. No.: US 2015/0229560 A1
(43) Pub. Date: Aug. 13, 2015

(54) METHOD, SWITCH AND SYSTEM FOR UPDATING ROUTE

(71) Applicant: TENCENTTECHNOLOGY (SHENZHEN) COMPANY LIMITED, Shenzhen (CN)

(72) Inventors: Zhun Qiu, Shenzhen (CN); Yi Ding, Shenzhen (CN); Pingping Chen, Shenzhen (CN); Bo Qian, Shenzhen (CN); Zijuan Qiu, Shenzhen (CN)

(21) Appl. No.: 14/431,594

(22) PCT Filed: Sep. 26, 2013
(86) PCT No.: PCT/CN2013/084279

§ 371 Date: Mar. 26, 2015

(30) Foreign Application Priority Data
Sep. 26, 2012 (CN) 201210362754.2

(51) Int. Cl. H04L 12/703; H04L 12/707; H04L 12/24; H04L 12/26

(52) U.S. Cl. CPC H04L 45/28; H04L 43/0811; H04L 45/22; H04L 41/0668

(57) ABSTRACT

The present disclosure provides a method, switch and system for updating a route, relating to computer network technologies. The method comprises detecting, by a current device, link states of at least two neighbor devices; when the current device detects that a link state of a first neighbor device is unreachable, setting, by the current device, a state of a routing item with an initial state being reachable among all routing items corresponding to the first neighbor device in an internal routing table to be unreachable; and detecting, by the current device, whether states of all routing items corresponding to each target subnet in the internal routing table are all unreachable, respectively; if yes, sending a route updating message to another neighbor device except the first neighbor device. According to the present disclosure, when detecting the neighbor device is broken, the current device directly updates the internal routing table without any calculation and notifies another neighbor device to update the internal routing table, so that the switch only needs to simply make a logical judgment to achieve route updating.

This application claims the benefit of priority from Chinese Patent Application, No. 201210362754.2, entitled “routing update method, switch, and system” and filed on Sep. 26, 2012, the entire content of which is hereby incorporated by reference.

### FIELD OF THE DISCLOSURE

The present disclosure relates to computer network technologies, and more particularly to a method, switch and system for updating a route.

### BACKGROUND

A routing protocol can achieve communication between any two nodes in a network, such as an Open Shortest Path First (OSPF) protocol, a Border Gateway Protocol (BGP), an Intermediate System to Intermediate System (ISIS) protocol (a layered link state routing protocol). For example, a switch may send an OSPF protocol message to all the neighbor switches by all the output ports. The OSPF protocol message is used for obtaining a link state of the neighbor switch. Then, each neighbor switch forwards the OSPF protocol message to all of its neighbor switches, and so on. As a result, because the link state information is frequently exchanged between these switches, all the switches can finally establish a link state database. The link state database is actually a topology structure of the entire network. Hence, each switch can be known about the number of switches in the entire network and connections between switches, so that each switch may construct its routing table using a shortest path routing algorithm according to the data in the link state database.

For example, FIG. 1 shows a structure of a data center network. The data center network includes a “core switch” identified by “C” and an “access switch” identified by “A”. The core switch is only connected with other switches in the network, and the access switch may be connected with the core switch and terminal devices in the specific network. In general, the number of the core switches C in the data center network is 2-4, such as C1, C2, C3, and C4 as shown in FIG. 1; the number of the access switches A is at least 100, such as A1˜An as shown in FIG. 1. After the switch operates the OSPF protocol in the data center network as shown in FIG. 1, the forwarding path from C to A is one-hop in normal cases; the forwarding path between any As is two-hop in normal cases, for example, there are 4 forwarding paths, A1-[C1|C2|C3|C4]-A4.

During network operation, as long as the link state of one switch is changed, the entire network needs to obtain a new structure of the network topology according to the OSPF protocol, and all the switches in the network need to re-calculate the forwarding path according to the new structure of the network topology. For example, after the link between C1 and A4 as shown in FIG. 1 is broken, all the switches need to re-calculate the forwarding path to A4, for example, A1 re-calculates and obtains 3 forwarding paths to A4, i.e., A1-C2-A4, A1-C3-A4, and A1-C4-A4, which is one path fewer than that before broken. Since when the link state of a switch is changed in the network, all the switches need to re-calculate the forwarding paths, the calculation resource of the switch is wasted, and it is not good for maintenance of all the routing information. For example, C1 will also calculate 3-hop detour paths (which is 1-hop before broken) to A4, i.e., C1-[A1|A2|A3|A5|An]-[C2|C3|C4]-A4, with the total number of 3*(n−2). Assuming n=102, after the link C1-A4 is broken, C1 will calculate 300 detour paths to A4, but actually, there is none of As to select a forwarding path from C1 t A4. Hence, the detour paths calculated by C1 are invalid, and such invalid calculation may expend a large amount of calculation resource, which may cause the design of the switch very complex and with high cost.

### SUMMARY

The present disclosure provides a method, switch and system for updating a route, which can solve a problem of valid calculation made by some switches when a link is broken according to the prior art.

In an aspect, the present disclosure provides a method for updating a route, comprising:

detecting, by a current device, link states of at least two neighbor devices, the neighbor device being an upstream device or a downstream device which is reachable by the current device through one hop;

when the current device detects that a link state of a first neighbor device is unreachable, setting, by the current device, a state of a routing item with an initial state being reachable among all routing items corresponding to the first neighbor device in an internal routing table to be unreachable; and

after the current device sets a state of at least one routing item to be unreachable due to the link state being changed, detecting, by the current device, whether states of all routing items corresponding to each target subnet in the internal routing table are all unreachable, respectively; when detecting that states of all routing items corresponding to one target subnet are all unreachable, sending a route updating message to another neighbor device except the first neighbor device, so that the another neighbor device sets a state of a routing item corresponding to both the current device and the target subnet in the internal routing table to be unreachable.

Further, before detecting link states of at least two neighbor devices, the method further comprises:

storing, by the current device, the internal routing table, wherein each routing item is identified by a two-dimensional coordinate in the internal routing table, one coordinate in the two-dimensional coordinate represents a neighbor device, and the other coordinate represents a target subnet; for each routing item, when a path across a neighbor device corresponding to the coordinate of the routing item to the target subnet corresponding to the other coordinate of the routing item is not a shortest path among all paths for the current device to the target subnet, setting the state of the routing item to be always unreachable.

Further, the method comprises:

when the current device detects that a link state of the first neighbor device is changed from unreachable to reachable, resuming, by the current device, a state of a routing item with an initial state being reachable among all routing items corresponding to the first neighbor device in the internal routing table from unreachable to reachable;

after the current device resumes a state of at least one routing item to be reachable due to the link state being changed, detecting, by the current device, whether states of all routing items corresponding to each target subnet in the internal routing table are changed from always unreachable to at least one reachable; when detecting that the states of all routing items corresponding to one target subnet are changed from always unreachable to at least one reachable, sending a route updating message to another neighbor device except the first neighbor device, so that the another neighbor device resumes a state of the routing item corresponding to both the current device and the target subnet in an internal routing table from unreachable to reachable.

Further, the method comprises:

receiving, by the current device, a route updating message from a second neighbor device; wherein the route updating message carries an identifier of the second neighbor device, an identifier of a target subnet and an identifier of whether a state is reachable;

updating, by the current device, the state of the routing item corresponding to both the second neighbor device and the target subnet in the internal routing table according to the identifier of whether the state is reachable; wherein the updating comprises changing the state of the routing item from reachable to unreachable, or resuming from unreachable to reachable;

after the current device sets a state of at least one routing item to be unreachable due to route updating, detecting, by the current device, whether states of all routing items corresponding to each target subnet in the internal routing table are all unreachable, respectively; when detecting that states of all routing items corresponding to one target subnet are all unreachable, sending a route updating message to another neighbor device except the second neighbor device, so that the another neighbor device sets the state of the routing item corresponding to both the current device and the target subnet in an internal routing table to be unreachable; and/or,

after the current device resumes a state of at least one routing item to be reachable due to route updating, detecting, by the current device, whether states of all routing items corresponding to each target subnet in the internal routing table are changed from always unreachable to at least one reachable; when detecting that states of all routing items corresponding to one target subnet are changed from always unreachable to at least one reachable, sending a route updating message to another neighbor device except the second neighbor device, so that the another neighbor device resumes the state of the routing item corresponding to both the current device and the target subnet in an internal routing table from unreachable to reachable.

Further, the method comprises:

sending, by the current device, a route updating message to another neighbor device with respect to a same routing item in a time interval which is not lower than a predetermined threshold.

In another aspect, the present disclosure provides a switch, comprising:

a link detecting module, configured to detect link states of at least two neighbor devices, the neighbor device being an upstream device or a downstream device which is reachable by the switch through one hop;

a route updating module, configured to, when the link detecting module detects that a link state of a first neighbor device is unreachable, set a state of a routing item with an initial state being reachable among all routing items corresponding to the first neighbor device in an internal routing table to be unreachable; and

an updating sending module, configured to, after a state of at least one routing item is set to be unreachable due to the link state being changed, detect whether states of all routing items corresponding to each target subnet in the internal routing table are all unreachable, respectively; when detecting that states of all routing items corresponding to one target subnet are all unreachable, send a route updating message to another neighbor device except the first neighbor device, so that another neighbor device sets a state of a routing item corresponding to both the current device and the target subnet in an internal routing table to be unreachable.

Further, the switch comprises:

a routing table storing module, configured to store the internal routing table, wherein each routing item is identified by a two-dimensional coordinate in the internal routing table, one coordinate in the two-dimensional coordinate represents a neighbor device, and the other coordinate represents a target subnet; for each routing item, when a path across a neighbor device corresponding to the coordinate of the routing item to a target subnet corresponding to the other coordinate of the routing item is not a shortest path among all paths for the current device to the target subnet, set the state of the routing item to be always unreachable.

Further, the route updating module is further configured to, when the link detecting module detects that a link state of the first neighbor device is changed from unreachable to reachable, resume a state of a routing item with an initial state being reachable among all routing items corresponding to the first neighbor device in the internal routing table from unreachable to reachable;

the updating sending module is further configured to, after the current device resumes a state of at least one routing item to be reachable due to the link state being changed, detecting, by the current device, whether states of all routing items corresponding to each target subnet in the internal routing table are changed from always unreachable to at least one reachable; when detecting that the states of all routing items corresponding to one target subnet are changed from always unreachable to at least one reachable, sending a route updating message to another neighbor device except the first neighbor device, so that the another neighbor device resumes a state of the routing item corresponding to both the current device and the target subnet in an internal routing table from unreachable to reachable.

Further, the switch comprises:

a message receiving module, configured to, receive a route updating message from a second neighbor device; wherein the route updating message carries an identifier of the second neighbor device, an identifier of a target subnet and an identifier of whether a state is reachable;

wherein the route updating module is further configured to, update the state of the routing item corresponding to both the second neighbor device and the target subnet in the internal routing table according to the identifier of whether the state is reachable; wherein the updating comprises changing the state of the routing item from reachable to unreachable, or resuming from unreachable to reachable;

the updating sending module is further configured to, after a state of at least one routing item is set to be unreachable due to route updating, detect whether states of all routing items corresponding to each target subnet in the internal routing table are all unreachable, respectively; when detecting that states of all routing items corresponding to one target subnet are all unreachable, send a route updating message to another neighbor device except the second neighbor device, so that the another neighbor device sets the state of the routing item corresponding to both the current device and the target subnet in an internal routing table to be unreachable; and/or,

the updating sending module is further configured to, after a state of at least one routing item is resumed to be reachable due to route updating, detect whether states of all routing items corresponding to each target subnet in the internal routing table are changed from always unreachable to at least one reachable; when detecting that states of all routing items corresponding to one target subnet are changed from always unreachable to at least one reachable, send a route updating message to another neighbor device except the second neighbor device, so that the another neighbor device resumes the state of the routing item corresponding to both the current device and the target subnet in an internal routing table from unreachable to reachable.

Further, the updating sending module is further configured to, send a route updating message to another neighbor device with respect to a same routing item in a time interval which is not lower than a predetermined threshold.

In yet another aspect, the present disclosure provides a network system, comprising a switch according to any one of previous aspects, wherein the switch constitutes a two-layer switching network or a more than two-layer switching network, wherein each switch is only connected with a switch in an upper layer or a switch in a lower layer.

The benefits achieved by the examples of the present disclosure are:

when detecting the neighbor device is broken, the current device directly updates the internal routing table without any calculation and selectively notifies another neighbor device to update the corresponding internal routing table, so that a problem of valid calculation made by some switches when the link is broken according to the prior art is solved, and the switch only needs to simply make a logical judgment to achieve route updating.

### BRIEF DESCRIPTION OF DRAWINGS

In order to make technical solutions of examples of the present disclosure clearer, accompanying drawings to be used in description of the examples will be simply introduced hereinafter. Obviously, the accompanying drawings to be described hereinafter are only some examples of the present disclosure. Those skilled in the art may obtain other drawings according to these accompanying drawings without creative labor.

FIG. 1 is a schematic diagram illustrating a structure of a data center network according to the prior art;

FIG. 2 is a flow chart illustrating a method for updating a route according to a first example of the present disclosure;

FIG. 3A is a schematic diagram illustrating a network structure related to a second example of the present disclosure;

FIG. 3B is a flow chart illustrating a method for updating a route according to the second example of the present disclosure;

FIG. 3C is a schematic diagram illustrating internal routing tables of several switches in an initial state according to the second example of the present disclosure;

FIG. 3D is a schematic diagram illustrating internal routing tables of several switches after updating the route according to the second example of the present disclosure;

FIG. 4A is a schematic diagram illustrating a network structure related to a third example of the present disclosure;

FIG. 4B is a flow chart illustrating a method for updating a route according to the third example of the present disclosure;

FIG. 4C is a schematic diagram illustrating internal routing tables of several switches in an initial state according to the third example of the present disclosure;

FIG. 4D is a schematic diagram illustrating internal routing tables of several switches after updating the route according to the third example of the present disclosure;

FIG. 5 is a schematic diagram illustrating a structure of a switch according to a fourth example of the present disclosure;

FIG. 6 is a schematic diagram illustrating a structure of a switch according to a fifth example of the present disclosure;

FIG. 7 is a schematic diagram illustrating a structure of a network system according to a sixth example of the present disclosure;

FIG. 8 is a schematic diagram illustrating a structure of a switch according to a seventh example of the present disclosure;

FIG. 9 is a schematic diagram illustrating a structure of a switch according to an eighth example of the present disclosure.

### DETAILED DESCRIPTION

In order to make the object, technical solution and merits of the present disclosure clearer, the present disclosure will be illustrated in detail hereinafter with reference to the accompanying drawings and specific examples.

### Example 1

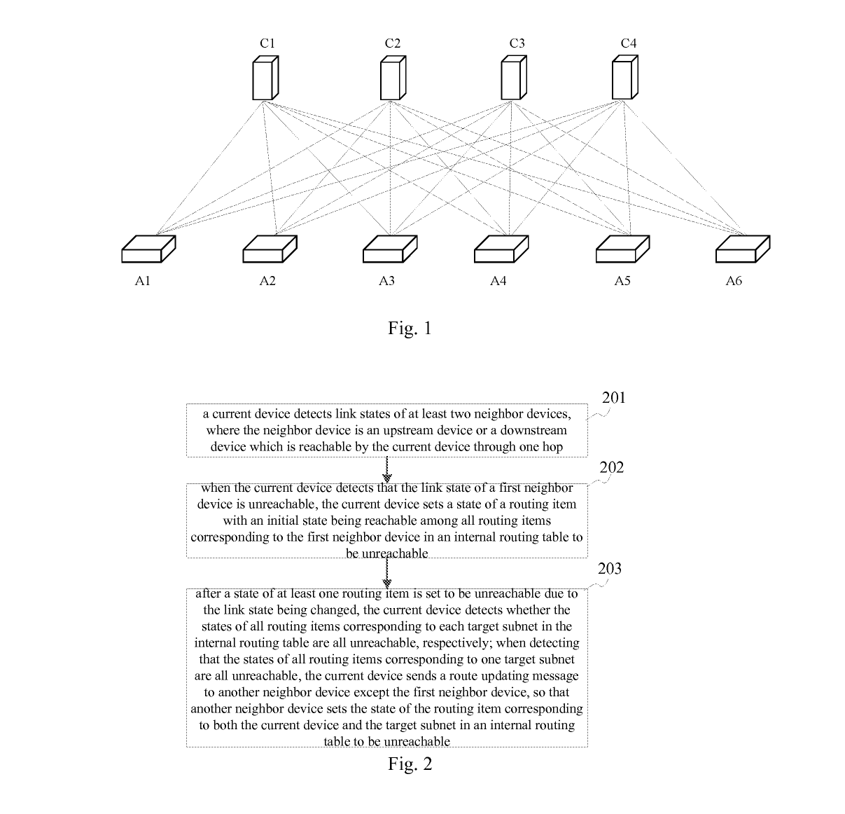

FIG. 2 is a flow chart illustrating a method for updating a route according to a first example of the present disclosure. The method can be applied to a switching network including two layers or more than two layers of devices, where each device is only connected with a device in an upper layer or a device in a lower layer. Herein, a device which is connected with a current device and located in the upper layer of the current device is called as an “upstream device”; a device which is connected with a current device and located in the lower layer of the current device is called as a “downstream device”. The method includes the following procedures.

In Block 201, a current device detects link states of at least two neighbor devices, where the neighbor device is an upstream device or a downstream device which is reachable by the current device through one hop.

In Block 202, when the current device detects that the link state of a first neighbor device is unreachable, the current device sets a state of a routing item with an initial state being reachable among all routing items corresponding to the first neighbor device in an internal routing table to be unreachable.

In Block 203, after a state of at least one routing item is set to be unreachable due to the link state being changed, the current device detects whether the states of all routing items corresponding to each target subnet in the internal routing table are all unreachable, respectively; when detecting that the states of all routing items corresponding to one target subnet are all unreachable, the current device sends a route updating message to another neighbor device except the first neighbor device, so that another neighbor device sets the state of the routing item corresponding to both the current device and the target subnet in an internal routing table to be unreachable.

Based on the above, according to the method for updating a route provided by the example of the present disclosure, when detecting the neighbor device is broken, the current device directly updates the internal routing table without any calculation and selectively notifies another neighbor device to update the corresponding internal routing table, so that a problem of valid calculation made by some switches when the link is broken according to the prior art is solved, and the switch only needs to simply make a logical judgment to achieve route updating.

For better description, in the following example, the method for updating a route is applied to a switching network including two layers of devices.

### Example 2

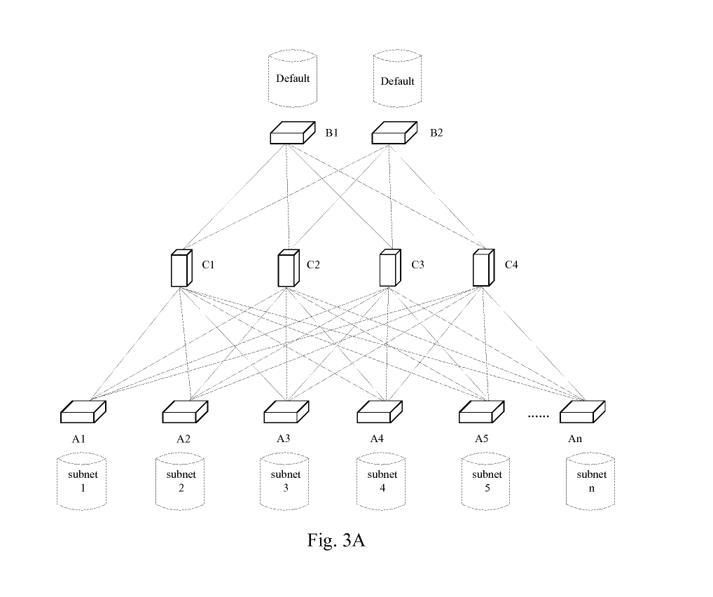

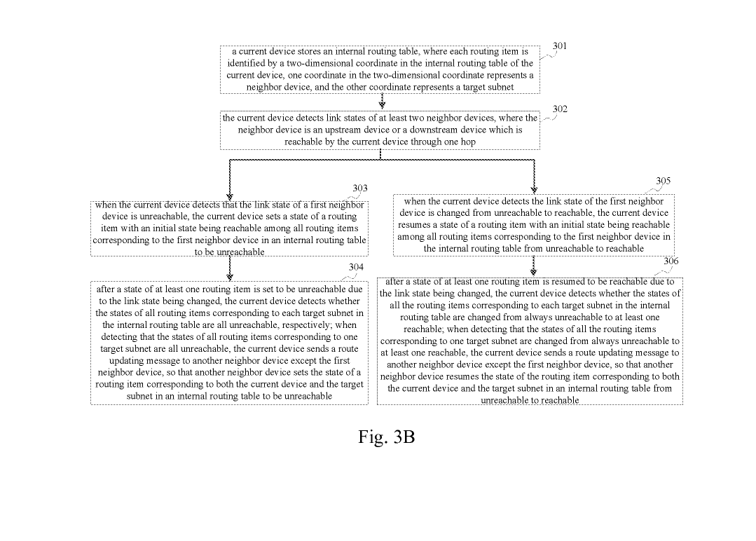

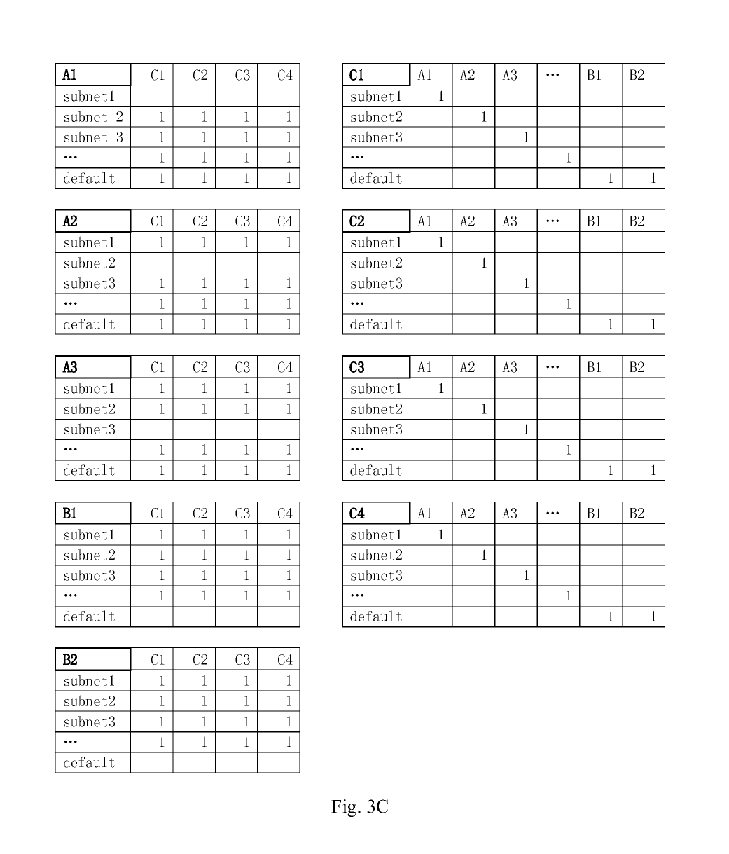

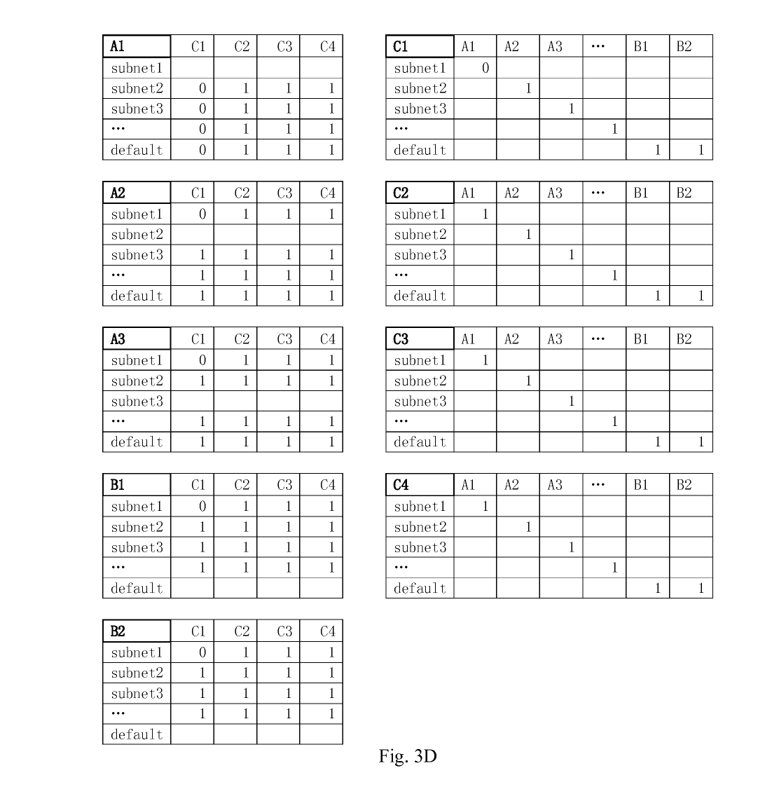

FIG. 3A is a schematic diagram illustrating a network structure related to a second example of the present disclosure. The network structure includes a switching network including two layers of devices in a data center. Each device is only connected with a device in an upper layer or a device in a lower layer. Herein, a device which is connected with a current device and located in the upper layer of the current device is called as an “upstream device”; a device which is connected with a current device and located in the lower layer of the current device is called as a “downstream device”. The structure includes the following:

4 core switches in the upper layer: C1, C2, C3, and C4.

n access switches in the lower layer: A1, A2, A3, A4, A5, and An, where A6 to Aₙ₋₁ are not shown. Each access switch is connected with a core switch, respectively. For example, A1 is connected with C1, C2, C3, and C4, respectively; A2 is connected with C1, C2, C3, and C4, respectively; A3 is connected with C1, C2, C3, and C4, respectively, etc. Each access switch corresponds to a subnet. For example, the subnet of access switch A1 is subnet1 of a specific server access network internally in the data center, the subnet of access switch A2 is subnet2 of a specific server access network internally in the data center, etc.

Two border switches B1 and B2 at the same layer with the access switch. The border switch belongs to a special access switch. The subnet corresponding to each border switch is “default”. The border switch has the function of the access switch, and can also operate other traditional routing protocols, such as OSPF, in order to inter-connect with the external network of the data center. That is, the border switch may aggregate the internal routes in the data center and then deliver to the external network, in order to achieve the inter-connection of the data center with the external network. Each border switch is connected with a core switch, respectively. For example, B1 is connected with C1, C2, C3, and C4, respectively; B2 is connected with C1, C2, C3, and C4, respectively.

In the aforementioned network topology, the devices at the same layer are not connected directly with each other.

FIG. 3B is a flow chart illustrating a method for updating a route according to the second example of the present disclosure. In the example, the method for updating a route is applied to the network structure as shown in FIG. 3A. When a switch is regarded as a current device, an upstream device or a downstream device connected with the current device is regarded as a neighbor device. The method includes the following procedures.

In Block 301, a current device stores an internal routing table, where each routing item is identified by a two-dimensional coordinate in the internal routing table of the current device, one coordinate in the two-dimensional coordinate represents a neighbor device, and the other coordinate represents a target subnet.

For each routing item, when a path across a neighbor device corresponding to the coordinate of the routing item to the target subnet corresponding to the other coordinate of the routing item is not a shortest path among all the paths for the current device to the target subnet, the state of the routing item is always unreachable.

In particular, each switch stores an internal routing table in advance. The forwarding path in the internal routing table is not the shortest path calculated in real time, but a fixed path on the basis of the shortest path. FIG. 3C is a schematic diagram illustrating internal routing tables of several switches in an initial state according to the second example of the present disclosure.

When the current device is the access switch A1, in the internal routing table of A1, each routing item is identified by a two-dimensional coordinate. Within the two-dimensional coordinate, the coordinates in the row include neighbor devices C1, C2, C3 and C4; the coordinates in the column include the target subnet: subnet1, subnet2, subnet3 . . . and default. For each routing item, if the number in the routing item is 1, it indicates “reachable”; if the number in the routing item is 0, it indicates “unreachable”; if the routing item is blank, it indicates “always unreachable”. For example, for target subnet3, when the neighbor devices are C1, C2, C3 and C4, the states of all the routing items are reachable, and the paths are all shortest 2-hop; for target subnet1, the shortest path from the current device A1 to the target subnet1 is through itself, so no matter which is the neighbor device, all the paths across the neighbor device to subnet1 are not the shortest, so that the states of all the routing items in the first row are always unreachable.

For the access switches A2 to An, it is similar to the access switch A1, which is not described in detail herein.

When the current device is the core switch C1, in the internal routing table of C1, each routing item is identified by a two-dimensional coordinate. Within the two-dimensional coordinate, the coordinates in the row include neighbor devices A1, A2, A3 . . . An, B1 and B2; the coordinates in the column include the target subnet: subnet1, subnet2, subnet3 . . . , and default. For each routing item, if the number in the routing item is 1, it indicates “reachable”; if the number in the routing item is 0, it indicates “unreachable”; if the routing item is blank, it indicates “always unreachable”. For example, for target subnet3, when the neighbor device is A3, the path across A3 to the subnet3 is the shortest 1-hop, so the state of the routing item is reachable; when the neighbor device is A1, although C1 can go along for example the path C1-A1-C2-A3 to subnet3, but it is not the shortest path originating from C1 and to subnet3, so that the state of the routing item is always unreachable; for the target subnet “default”, when the neighbor device is B1 or B2, the path across B1 or B2 to default is the shortest 1-hop, so the state of the routing item is reachable, but when the neighbor device is one of A1 to An, although C1 can go along for example the path C1-A1-C2-B1 to default, but it is not the shortest path originating from C1 and to default, so that the state of the corresponding routing item is always unreachable.

For the core switches C2 to C4, it is similar to the core switch C1, which is not described in detail herein.

When the current device is the border switch B1, in the internal routing table of B1, each routing item is identified by a two-dimensional coordinate. Within the two-dimensional coordinate, the coordinates in the row include neighbor devices C1, C2, C3 and C4; the coordinates in the column include the target subnet: subnet1, subnet2, subnet3 . . . , and default. For each routing item, if the number in the routing item is 1, it indicates “reachable”; if the number in the routing item is 0, it indicates “unreachable”; if the routing item is blank, it indicates “always unreachable”. For example, for target subnet3, when the neighbor devices are C1, C2, C3 and C4, the states of all the routing items are reachable, and the paths are all shortest 2-hop; for target subnet “default”, the shortest path from the current device B1 to the target default is through itself, so no matter which is the neighbor device, all the paths across the neighbor device to default are not the shortest, so that the states of all the routing items in the lowest row are always unreachable.

For the border switch B2, it is similar to the border switch B1, which is not described in detail herein.

In Block 302, the current device detects link states of at least two neighbor devices, where the neighbor device is an upstream device or a downstream device which is reachable by the current device through one hop.

When the current device is the access switch A1, the devices which are reachable by one hop include the core switches at the upper layer C1, C2, C3 and C4, so A1 detects the link state of C1, C2, C3 and C4, respectively.

In a similar way, A2 to An also detect the link state of C1, C2, C3 and C4, respectively.

When the current device is the core switch C1, the devices which are reachable by one hop include the access switches at the lower layer A1 to An and the border switches B1, B2, so C1 detects the link state of A1 to An, B1 and B2, respectively.

In a similar way, C2 also detects the link state of A1 to An, B1, and B2, respectively.

When the current device is the border switch B1, the devices which are reachable by one hop include the core switches at the upper layer C1, C2, C3 and C4, so B1 detects the link state of C1, C2, C3 and C4, respectively.

In a similar way, B2 also detects the link state of C1, C2, C3 and C4, respectively.

That is, two neighbor devices detect the link state of each other.

In Block 303, when the current device detects that the link state of a first neighbor device is unreachable, the current device sets a state of a routing item with an initial state being reachable among all routing items corresponding to the first neighbor device in an internal routing table to be unreachable.

The first neighbor device refers to one of at least two neighbor devices of the current device. Herein, “first” is only for description to differentiate the devices, but not intended to include other special meaning.

When the current device is the access switch A1, assuming A1 detects that the link state of C1 is unreachable, A1 sets a state of a routing item with an initial state being reachable among all routing items corresponding to C1 in an internal routing table to be unreachable, as shown in FIG. 3D.

When the current device is the core switch C1, when C1 detects that the link state of A1 is unreachable, C1 sets a state of a routing item with an initial state being reachable among all routing items corresponding to A1 in an internal routing table to be unreachable, as shown in FIG. 3D.

In Block 304, after a state of at least one routing item is set to be unreachable due to the link state being changed, the current device detects whether the states of all routing items corresponding to each target subnet in the internal routing table are all unreachable, respectively; when detecting that the states of all routing items corresponding to one target subnet are all unreachable, the current device sends a route updating message to another neighbor device except the first neighbor device, so that another neighbor device sets the state of a routing item corresponding to both the current device and the target subnet in an internal routing table to be unreachable.

When the current device is the access switch A1, assuming A1 detects that the link state of C1 is unreachable, A1 first sets a state of a routing item with an initial state being reachable among all routing items corresponding to C1 in an internal routing table to be unreachable; then A1 detects whether the states of all routing items corresponding to each target subnet in the internal routing table are all unreachable, respectively; when detecting that the states of all routing items corresponding to none of the target subnets are all unreachable (for the target subnets from subnet2 to default, there are four routing items being reachable before, but now it is changed to be three routing items being reachable now), no further processing is needed.

When the current device is the core switch C1, assuming C1 detects that the link state of A1 is unreachable, C1 sets a state of a routing item with an initial state being reachable among all routing items corresponding to A1 in an internal routing table to be unreachable, i.e., sets the “1” for the routing item at the first row and first column to be “0”, as shown in FIG. 3D.

Thus, C1 detects whether the states of all routing items corresponding to each target subnet in the internal routing table are all unreachable, respectively; when detecting that the states of all routing items corresponding to subnet1 become all unreachable (i.e., the routing items at the first row all become unreachable), C1 sends a route updating message to another neighbor device except A1, so that another neighbor device sets the state of a routing item corresponding to both C1 and subnet1 in an internal routing table to be unreachable. As shown in FIG. 3D, for A2 to An, B1 and B2, the routing items corresponding to both C1 and subnet1 are all changed from “1” to “0”.

In Block 305, when the current device detects the link state of the first neighbor device is changed from unreachable to reachable, the current device resumes a state of a routing item with an initial state being reachable among all routing items corresponding to the first neighbor device in the internal routing table from unreachable to reachable.

When the current device is the core switch C1, assuming C1 detects that the link state of A1 is changed from unreachable to reachable, C1 resumes a state of a routing item with an initial state being reachable among all routing items corresponding to A1 in the internal routing table to be reachable, i.e., sets the “0” for the routing item at the first row and first column to be “1”, as shown in FIG. 3C.

In Block 306, after a state of at least one routing item is resumed to be reachable due to the link state being changed, the current device detects whether the states of all the routing items corresponding to each target subnet in the internal routing table are changed from always unreachable to at least one reachable; when detecting that the states of all the routing items corresponding to one target subnet are changed from always unreachable to at least one reachable, the current device sends a route updating message to another neighbor device except the first neighbor device, so that another neighbor device resumes the state of the routing item corresponding to both the current device and the target subnet in an internal routing table from unreachable to reachable.

C1 detects whether the states of all the routing items corresponding to each target subnet in the internal routing table are changed from always unreachable to at least one reachable; when detecting that the states of all the routing items corresponding to subnet1 are changed from always unreachable to at least one reachable (i.e., the routing item at the first row and first column becomes reachable), C1 sends a route updating message to another neighbor device except A1, so that another neighbor device resumes the state of the routing item corresponding to both C1 and subnet1 in an internal routing table from unreachable to reachable. As shown in FIG. 3C, for A2 to An, B1 and B2, the routing items corresponding to C1 and subnet1 are all changed from “0” to “1”.

Based on the above, according to the method for updating a route provided by the example of the present disclosure, when detecting the neighbor device is broken, the current device directly updates the internal routing table without any calculation and selectively notifies another neighbor device to update the corresponding internal routing table, so that a problem of valid calculation made by some switches when the link is broken according to the prior art is solved, and the switch only needs to simply make a logical judgment to achieve route updating.

### Example 3

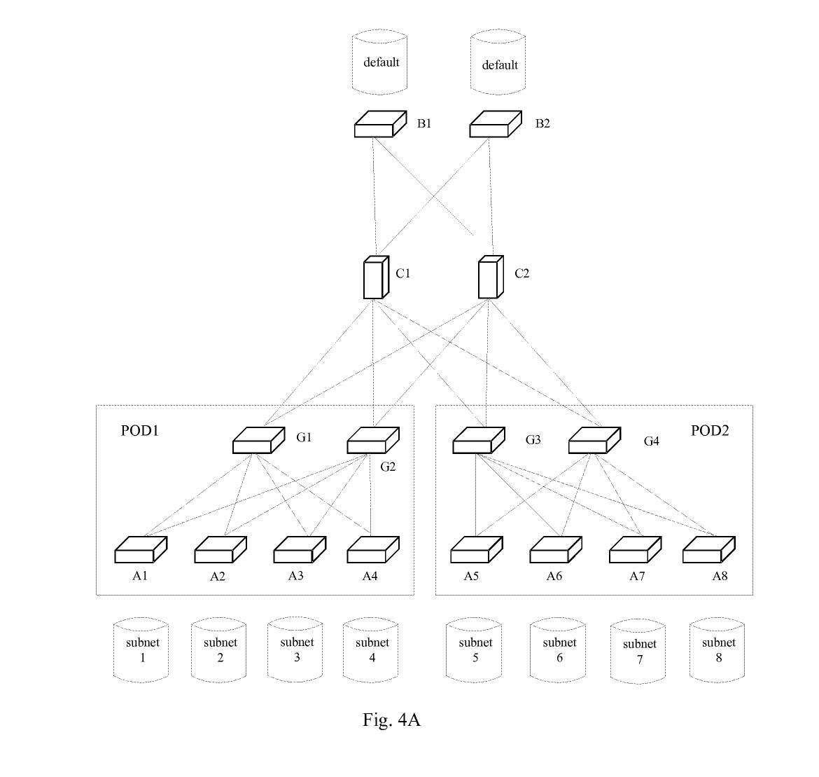

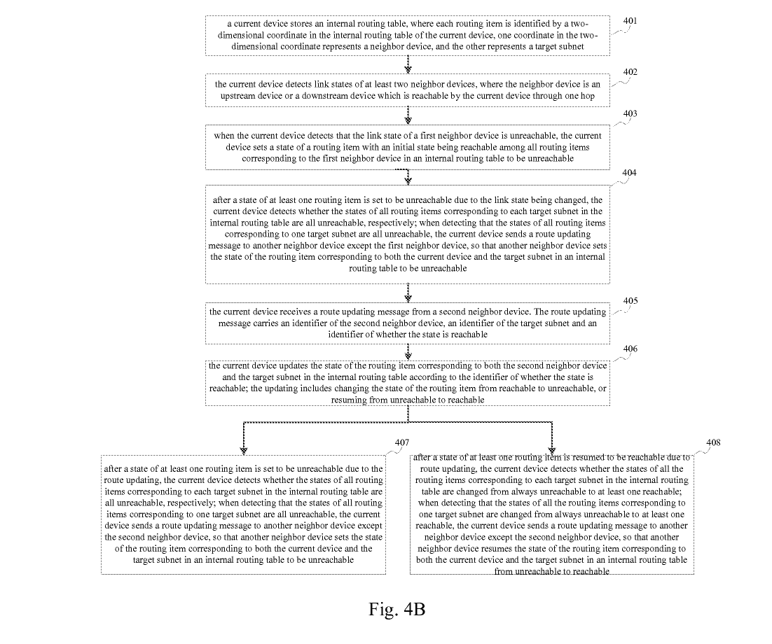

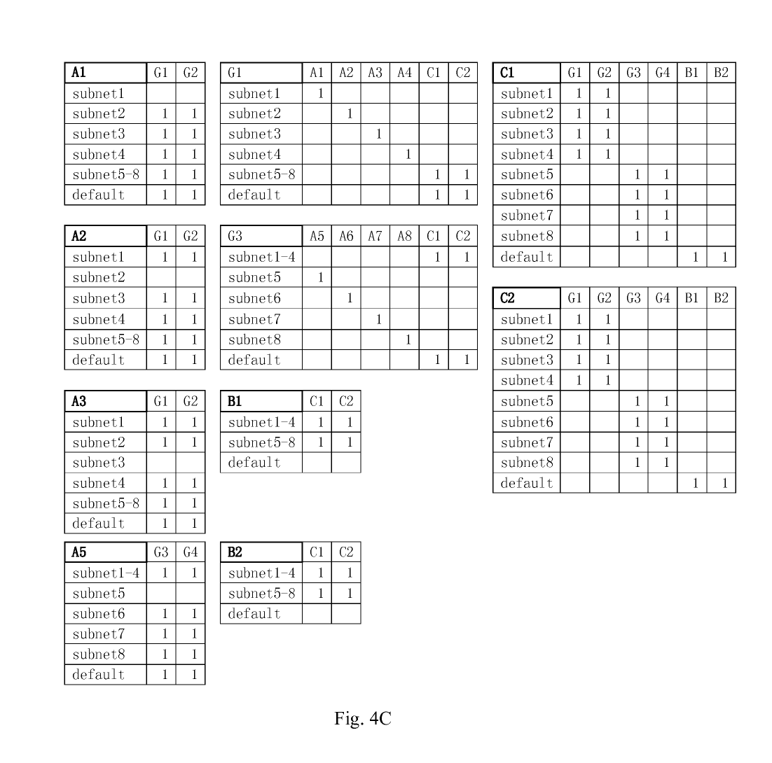

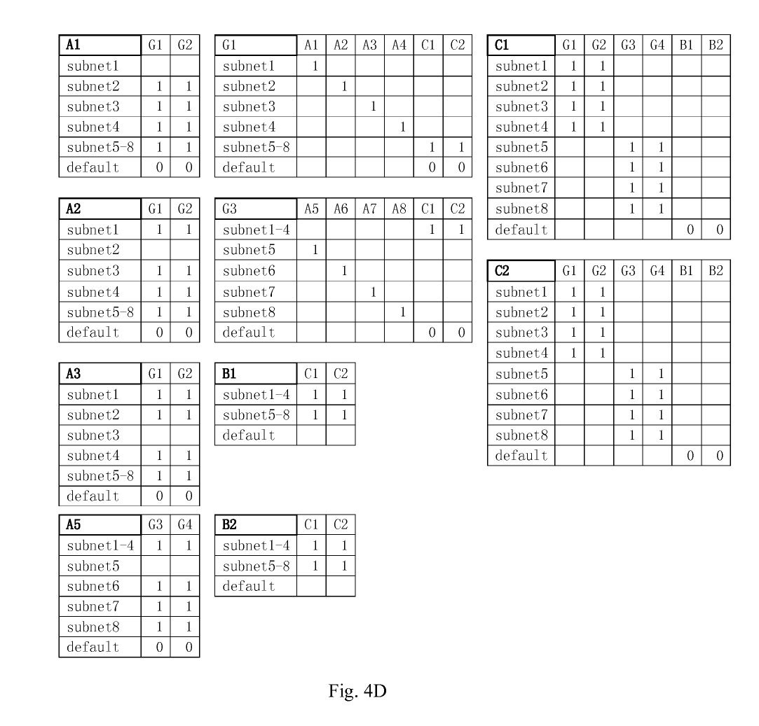

FIG. 4A is a schematic diagram illustrating a structure of a network related to a third example of the present disclosure. The network structure includes a switching network including three layers of devices in a data center. The structure includes the following:

2 core switches in the upper layer: C1, C2.

Two border switches B1 and B2 at the middle layer. The border switch belongs to a special access switch. The subnet corresponding to each border switch is “default”. The border switch has the function of the access switch, and can also operate other traditional routing protocols, such as OSPF, in order to inter-connect with the external network of the data center. That is, the border switch may aggregate the internal routes in the data center and then deliver to the external network, in order to achieve the inter-connection of the data center with the external network. Each border switch is connected with a core switch, respectively. For example, B1 is connected with C1 and C2, respectively; B2 is connected with C1 and C2, respectively.

4 aggregation switches G1, G2, G3 and G4. Each aggregation switch is connected with a core switch, respectively. For example, G1 is connected with C1 and C2, respectively; G3 is connected with C1 and C2, respectively, etc. There are several access switches at the lower layer of each aggregation switch. G1, G2 and its subordinate access switches constitutes a first device cluster POD1; G3, G4 and its subordinate access switches constitutes a second device cluster POD2.

8 access switches at the lowest layer: A1, A2, A3, A4, A5, A6, A7 and A8. A1, A2, A3, and A4 belong to POD1, connected with G1 and G2, respectively; A5, A6, A7 and A8 belong to POD2, connected with G3 and G4, respectively. Each access switch corresponds to a subnet. For example, the subnet of access switch A1 is subnet1 of a specific server access network internally in the data center, the subnet of access switch A2 is subnet2 of a specific server access network internally in the data center, etc.

In the aforementioned network topology, the devices at the same layer are not connected directly with each other.

FIG. 4B is a flow chart illustrating a method for updating a route according to the third example of the present disclosure. In the example, the method for updating a route is applied to the network structure as shown in FIG. 4A. When a switch is regarded as a current device, an upstream device or a downstream device connected with the current device is regarded as a neighbor device. The method includes the following procedures.

In Block 401, a current device stores an internal routing table, where each routing item is identified by a two-dimensional coordinate in the internal routing table of the current device, one coordinate in the two-dimensional coordinate represents a neighbor device, and the other represents a target subnet.

For each routing item, when a path across a neighbor device corresponding to the coordinate of the routing item to a target subnet corresponding to the other coordinate of the routing item is not a shortest path among all the paths for the current device to the target subnet, the state of the routing item is always unreachable.

In particular, each switch stores an internal routing table in advance. The forwarding path in the internal routing table is not the shortest path calculated in real time, but a fixed path on the basis of the shortest path. FIG. 4C is a schematic diagram illustrating internal routing tables of several switches in an initial state according to the second example of the present disclosure.

When the current device is the access switch A1, in the internal routing table of A1, each routing item is identified by a two-dimensional coordinate. Within the two-dimensional coordinate, the coordinates in the row include neighbor devices G1 and G2; the coordinates in the column include the target subnet: subnet1, subnet2, subnet3 . . . , subnet8 and default. For each routing item, if the number in the routing item is 1, it indicates “reachable”; if the number in the routing item is 0, it indicates “unreachable”; if the routing item is blank, it indicates “always unreachable”. For example, for target subnet3, no matter the neighbor device is G1 and G2, the states of the routing items are reachable, and the paths are all shortest 2-hop; for target subnet1, the shortest path from the current device A1 to the target subnet1 is through itself, so no matter which is the neighbor device, all the paths across the neighbor device to subnet1 are not the shortest, so that the states of the routing items in the first row are always unreachable.

For the access switches A2 to A8, it is similar to the access switch A1, which is not described in detail herein.

When the current device is the aggregation switch G1, in the internal routing table of G1, each routing item is identified by a two-dimensional coordinate. Within the two-dimensional coordinate, the coordinates in the row include neighbor devices A1, A2, A3, A4, C1 and C2; the coordinates in the column include the target subnet: subnet1, subnet2, subnet3 . . . , subnet8 and default. For each routing item, if the number in the routing item is 1, it indicates “reachable”; if the number in the routing item is 0, it indicates “unreachable”; if the routing item is blank, it indicates “always unreachable”. For example, for target subnet3, when the neighbor device is A3, the path across A3 to the subnet3 is the shortest 1-hop, so the state of the routing item is reachable; when the neighbor device is A1, although G1 can go along for example the path G1-A1-G2-A3 to subnet3, but it is not the shortest path originating from G1 and to subnet3, so that the state of the routing item is always unreachable; for the target subnet “default”, when the neighbor device is C1 or C2, the path across C1 or C2 to default is the shortest 1-hop, so the state of the routing item is reachable, but when the neighbor device is one of A1 to A4, although G1 can go along for example the path G1-A1-G2-C1-B1 to default, but it is not the shortest path originating from G1 and to default, so that the state of the corresponding routing item is always unreachable.

For the aggregation switches G2, G3 and G4, it is similar to the core switch G1, which is not described in detail herein.

When the current device is the core switch C1, in the internal routing table of C1, each routing item is identified by a two-dimensional coordinate. Within the two-dimensional coordinate, the coordinates in the row include neighbor devices G1, G2, G3, G4, B1 and B2; the coordinates in the column include the target subnet: subnet1, subnet2, subnet3 . . . , subnet8 and default. For each routing item, if the number in the routing item is 1, it indicates “reachable”; if the number in the routing item is 0, it indicates “unreachable”; if the routing item is blank, it indicates “always unreachable”. For example, for target subnet3, when the neighbor device is G1, the path across G1 to the subnet3 is the shortest 2-hop, so the state of the routing item is reachable; when the neighbor device is G3, although C1 can go along for example the path C1-G3-C2-G1-A3 to subnet3, but it is not the shortest path originating from C1 and to subnet3, so that the state of the routing item is always unreachable.

For the core switch C2, it is similar to the core switch C1, which is not described in detail herein.

When the current device is the border switch B1, in the internal routing table of B1, each routing item is identified by a two-dimensional coordinate. Within the two-dimensional coordinate, the coordinates in the row include neighbor devices C1 and C2, the coordinates in the column include the target subnet: subnet1, subnet2, subnet3 . . . , subnet8 and default. For each routing item, if the number in the routing item is 1, it indicates “reachable”; if the number in the routing item is 0, it indicates “unreachable”; if the routing item is blank, it indicates “always unreachable”. For example, for target subnet3, when the neighbor devices are C1 and C2, the states of all the routing items are reachable, and the paths are all shortest 3-hop; for target subnet “default”, the shortest path from the current device B1 to the target default is through itself, so no matter which is the neighbor device, all the paths across the neighbor device to default are not the shortest, so that the states of all the routing items in the lowest row are always unreachable.

For the border switch B2, it is similar to the border switch B1, which is not described in detail herein.

In Block 402, the current device detects link states of at least two neighbor devices, where the neighbor device is an upstream device or a downstream device which is reachable by the current device through one hop.

When the current device is the access switch A1, the devices which are reachable by one hop include the core switches at the upper layer G1 and G2, so A1 detects the link state of G1 and G2, respectively.

In a similar way, A2 to A4 also detect the link state of G1 and G2, respectively. A5 to A8 detect the link state of G3 and G4, respectively

When the current device is the aggregation switch G1, the devices which are reachable by one hop include the aggregation switches at the upper layer C1 and C2, and the access switches at the lower layer A1, A2, A3 and A4, so G1 detects the link state of A1 to A4, C1 and C2, respectively.

In a similar way, G2 also detects the link state of A1 to A4, C1 and C2, respectively. G3 and G4 detect the link state of A5 to A8, C1 and C2, respectively.

When the current device is the core switch C1, the devices which are reachable by one hop include the aggregation switches at the lower layer G1 to G4 and the border switches B1, B2, so C1 detects the link state of A1 to A4, B1 and B2, respectively.

In a similar way, C2 also detects the link state of A1 to A4, B1 and B2, respectively.

When the current device is the border switch B1, the devices which are reachable by one hop include the core switches at the upper layer C1 and C2, so B1 detects the link state of C1 and C2, respectively.

In a similar way, B2 also detects the link state of C1 and C2, respectively.

That is, two neighbor devices detect the link state of each other.

In Block 403, when the current device detects that the link state of a first neighbor device is unreachable, the current device sets a state of a routing item with an initial state being reachable among all routing items corresponding to the first neighbor device in an internal routing table to be unreachable.

The first neighbor device refers to one of at least two neighbor devices of the current device. Herein, “first” is only for description to differentiate the devices, but not intended to include other special meaning.

In the following steps, take the default route withdraw of B1 and B2 as an example. For example, when the data center does not need to access an external network, the withdrawing default routes of B1 and B2 will occur. For the case of other path being broken or withdraw, those skilled in the art may easily extend the method, which is not described in detail herein.

When the current device is the core switch C1, assuming C1 detects that the link states of both B1 and B2 are unreachable, C1 sets a state of a routing item with an initial state being reachable among all routing items corresponding to B1 and B2 in an internal routing table to be unreachable, i.e., sets all the “1” for the routing items at the lowest row to be “0”, as shown in FIG. 4D.

At the same time, the core switch C2 also sets a state of a routing item with an initial state being reachable among all routing items corresponding to B1 and B2 in an internal routing table to be unreachable, i.e., sets all the “1” for the routing items at the lowest row to be “0”, as shown in FIG. 4D.

In Block 404, after a state of at least one routing item is set to be unreachable due to the link state being changed, the current device detects whether the states of all routing items corresponding to each target subnet in the internal routing table are all unreachable, respectively; when detecting that the states of all routing items corresponding to one target subnet are all unreachable, the current device sends a route updating message to another neighbor device except the first neighbor device, so that another neighbor device sets the state of the routing item corresponding to both the current device and the target subnet in an internal routing table to be unreachable.

When the current device is the core switch C1, after C1 sets a state of a routing item with an initial state being reachable among all routing items corresponding to B1 and B2 in an internal routing table to be unreachable, C1 detects whether the states of all routing items corresponding to each target subnet in the internal routing table are all unreachable, respectively; when detecting that the states of all routing items corresponding to default become all unreachable (i.e., the routing items at the lowest row all become unreachable), C1 sends a route updating message to another neighbor device except B1 and B2, so that another neighbor device sets the state of the routing item corresponding to both C1 and default in an internal routing table to be unreachable. As shown in FIG. 4D, for G1, G2, G3 and G4, the routing items corresponding to both C1 and default are all changed from “1” to “0”.

In a similar way, C2 sets a state of a routing item with an initial state being reachable among all routing items corresponding to B1 and B2 in an internal routing table to be unreachable, C1 detects whether the states of all routing items corresponding to each target subnet in the internal routing table are all unreachable, respectively; when detecting that the states of all routing items corresponding to default become all unreachable (i.e., the routing items at the lowest row all become unreachable), C2 sends a route updating message to another neighbor device except B1 and B2, so that another neighbor device sets the state of the routing item corresponding to both C2 and default in an internal routing table to be unreachable. As shown in FIG. 4D, for G1, G2, G3 and G4, the routing items corresponding to both C2 and default are all changed from “1” to “0”.

In Block 402 and Block 403, is triggered by the current device detecting the link states of the neighbor devices. The current device may also trigger the route updating by receiving a route updating message from the neighbor devices. It may refer to the following steps.

In Block 405, the current device receives a route updating message from a second neighbor device. The route updating message carries an identifier of the second neighbor device, an identifier of the target subnet and an identifier of whether the state is reachable.

In Block 406, the current device updates the state of the routing item corresponding to both the second neighbor device and the target subnet in the internal routing table according to the identifier of whether the state is reachable; the updating includes changing the state of the routing item from reachable to unreachable, or resuming from unreachable to reachable.

In Block 407, after a state of at least one routing item is set to be unreachable due to the route updating, the current device detects whether the states of all routing items corresponding to each target subnet in the internal routing table are all unreachable, respectively; when detecting that the states of all routing items corresponding to one target subnet are all unreachable, the current device sends a route updating message to another neighbor device except the second neighbor device, so that another neighbor device sets the state of the routing item corresponding to both the current device and the target subnet in an internal routing table to be unreachable.

In Block 408, after a state of at least one routing item is resumed to be reachable due to route updating, the current device detects whether the states of all the routing items corresponding to each target subnet in the internal routing table are changed from always unreachable to at least one reachable; when detecting that the states of all the routing items corresponding to one target subnet are changed from always unreachable to at least one reachable, the current device sends a route updating message to another neighbor device except the second neighbor device, so that another neighbor device resumes the state of the routing item corresponding to both the current device and the target subnet in an internal routing table from unreachable to reachable.

In particular, when the current device is the aggregation switch G1, G1 may receive a route updating message from C1. The route updating message carries an identifier of C1, an identifier of default and an identifier of whether the state is reachable. Then G1 updates the state of the routing item corresponding to both C1 and default in the internal routing table from “1” to “0”.

In a similar way, G1 may receive a route updating message from C2. The route updating message carries an identifier of C2, an identifier of default and an identifier of whether the state is reachable. Then G1 updates the state of the routing item corresponding to both C2 and default in the internal routing table from “1” to “0”.

Then, G1 may detect whether the states of all routing items corresponding to each target subnet in the internal routing table are all unreachable, respectively; when detecting that the states of all routing items corresponding to default are all unreachable (i.e., the routing items at the lowest row all become unreachable), G1 may send a route updating message to another neighbor device A1 to A4 except C1 and C2, so that A1 to A4 may set the state of the routing item corresponding to both G1 and default in an internal routing table from “1” to “0”.

Similarly, G2, G3 and G4 may perform the same operations as G1. The final internal routing tables after route updating are shown in FIG. 4D.

When the data center needs to access the external network again, the default routes of B2 and B2 are resumed, thus the corresponding route updating process is basically an inverse process of the above-described process, which is not described in detail herein. But it should be noted that, in a preferred example, a time interval for the current device sending a route updating message to another neighbor device with respect to a same routing item is not lower than a predetermined threshold. That is, when the current device needs to send a route updating message to another neighbor device with respect to a same routing item, the time interval between the time instants for sending two route updating messages is not lower than a predetermined threshold to avoid the flapping. The predetermined threshold may be 2 seconds, or other values specified by the designer.

Based on the above, according to the method for updating a route provided by the example of the present disclosure, besides the benefit provided by the previous example, by receiving a route updating message from the second neighbor device, directly updating the internal routing table without any calculation and selectively sending a route updating message to another neighbor device except the second neighbor device, the problem of valid calculation made by some switches when the link is broken according to the prior art is solved, and the switch only needs to simply make a logical judgment to achieve route updating.

The following example is an apparatus example of the present disclosure. The apparatus may execute the method as described above in the method example of the present disclosure. For any technical details in the apparatus example which are not disclosed herein, please refer to the method example of the present disclosure.

### Example 4

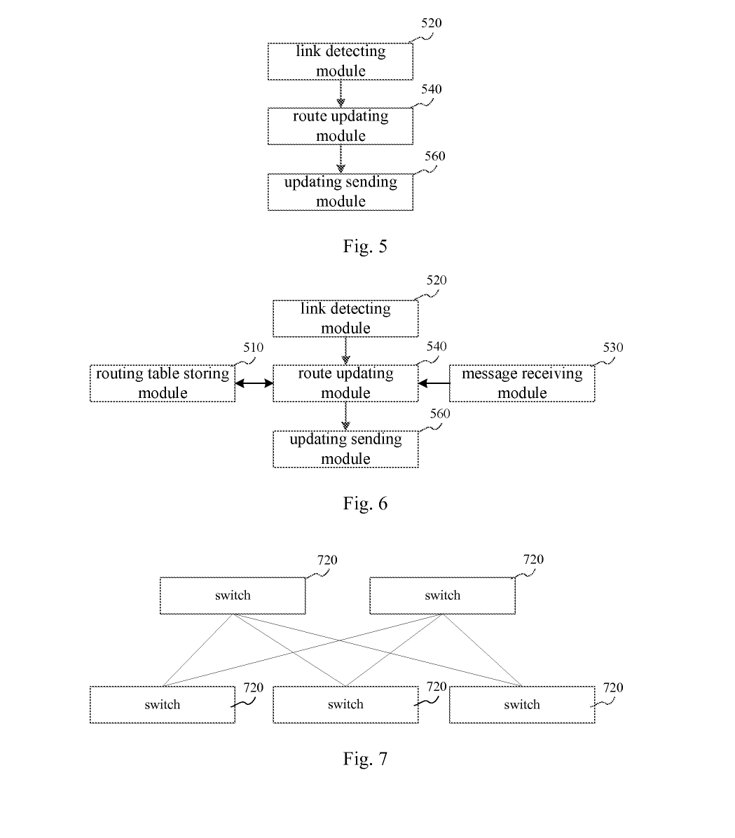

FIG. 5 is a schematic diagram illustrating a structure of a switch according to a fourth example of the present disclosure. The switch may be one of a core switch, an aggregation switch, an access switch and a border switch. The switch includes a link detecting module 520, a route updating module 540 and an updating sending module 560.

The link detecting module 520 is configured to detect link states of at least two neighbor devices, where the neighbor device is an upstream device or a downstream device which is reachable by the switch through one hop.

The route updating module 540 is configured to, when the link detecting module 520 detects that the link state of a first neighbor device is unreachable, set a state of a routing item with an initial state being reachable among all routing items corresponding to the first neighbor device in an internal routing table to be unreachable.

The updating sending module 560 is configured to, after a state of at least one routing item is set to be unreachable by the route updating module 540 due to the link state being changed, detect whether the states of all routing items corresponding to each target subnet in the internal routing table are all unreachable, respectively; when detecting that the states of all routing items corresponding to one target subnet are all unreachable, send a route updating message to another neighbor device except the first neighbor device, so that another neighbor device sets the state of the routing item corresponding to both the current device and the target subnet in an internal routing table to be unreachable.

Based on the above, according to the switch provided by the example of the present disclosure, when detecting the neighbor device is broken, the current device directly updates the internal routing table without any calculation and selectively notifies another neighbor device to update the corresponding internal routing table, so that a problem of valid calculation made by some switches when the link is broken according to the prior art is solved, and the switch only needs to simply make a logical judgment to achieve route updating.

### Example 5

FIG. 6 is a schematic diagram illustrating a structure of a switch according to a fifth example of the present disclosure. The switch may be one of a core switch, an aggregation switch, an access switch and a border switch. The switch includes a routing table storing module 510, a link detecting module 520, a message receiving module 530, a route updating module 540 and an updating sending module 560.

The routing table storing module 510 is configured to store the internal routing table, where each routing item is identified by a two-dimensional coordinate in the internal routing table of the current device, one coordinate in the two-dimensional coordinate represents a neighbor device, and the other represents a target subnet; for each routing item, when a path across a neighbor device corresponding to the coordinate of the routing item to a target subnet corresponding to the other coordinate of the routing item is not a shortest path among all the paths for the current device to the target subnet, set the state of the routing item to be always unreachable.

The link detecting module 520 is configured to detect link states of at least two neighbor devices, where the neighbor device is an upstream device or a downstream device which is reachable by the current device through one hop.

The route updating module 540 is configured to, when the link detecting module 520 detects that the link state of a first neighbor device is unreachable, set a state of a routing item with an initial state being reachable among all routing items corresponding to the first neighbor device in an internal routing table to be unreachable.

The updating sending module 560 is configured to, after a state of at least one routing item is set to be unreachable by the route updating module 540 due to the link state being changed, detect whether the states of all routing items corresponding to each target subnet in the internal routing table are all unreachable, respectively; when detecting that the states of all routing items corresponding to one target subnet are all unreachable, send a route updating message to another neighbor device except the first neighbor device, so that another neighbor device sets the state of the routing item corresponding to both the current device and the target subnet in an internal routing table to be unreachable.

The route updating module 540 is further configured to, when the link detecting module 520 detects the link state of the first neighbor device is changed from unreachable to reachable, resume a state of a routing item with an initial state being reachable among all routing items corresponding to the first neighbor device in the internal routing table from unreachable to reachable.

The updating sending module 560 is further configured to, after a state of at least one routing item is resumed to be reachable by the route updating module 540 due to the link state being changed, detect whether the states of all the routing items corresponding to each target subnet in the internal routing table are changed from always unreachable to at least one reachable; when detecting that the states of all the routing items corresponding to one target subnet are changed from always unreachable to at least one reachable, send a route updating message to another neighbor device except the first neighbor device, so that another neighbor device resumes the state of the routing item corresponding to both the current device and the target subnet in an internal routing table from unreachable to reachable.

The message receiving module 530 is configured to receive a route updating message from a second neighbor device; where the route updating message carries an identifier of the second neighbor device, an identifier of the target subnet and an identifier of whether the state is reachable.

The route updating module 540 is further configured to, update the state of the routing item corresponding to both the second neighbor device and the target subnet in the internal routing table according to the identifier of whether the state is reachable received by the message receiving module 530; the updating includes changing the state of the routing item from reachable to unreachable, or resuming from unreachable to reachable.

The updating sending module 560 is further configured to, after a state of at least one routing item is set to be unreachable by the route updating module 540 due to the route updating, detect whether the states of all routing items corresponding to each target subnet in the internal routing table are all unreachable, respectively; when detecting that the states of all routing items corresponding to one target subnet are all unreachable, send a route updating message to another neighbor device except the second neighbor device, so that another neighbor device sets the state of the routing item corresponding to both the current device and the target subnet in an internal routing table to be unreachable.

And/or, the updating sending module 560 is further configured to, after a state of at least one routing item is resumed to be reachable by the route updating module 540 due to route updating, detect whether the states of all the routing items corresponding to each target subnet in the internal routing table are changed from always unreachable to at least one reachable; when detecting that the states of all the routing items corresponding to one target subnet are changed from always unreachable to at least one reachable, send a route updating message to another neighbor device except the second neighbor device, so that another neighbor device resumes the state of the routing item corresponding to both the current device and the target subnet in an internal routing table from unreachable to reachable.

The updating sending module 560 is further configured to send a route updating message to another neighbor device with respect to a same routing item in a time interval which is not lower than a predetermined threshold.

Based on the above, according to the switch provided by the example of the present disclosure, besides the benefit provided by the previous example, by receiving a route updating message from the second neighbor device, directly updating the internal routing table without any calculation and selectively sending a route updating message to another neighbor device except the second neighbor device, the problem of valid calculation made by some switches when the link is broken according to the prior art is solved, and the switch only needs to simply make a logical judgment to achieve route updating.

### Example 6

FIG. 7 is a schematic diagram illustrating a structure of a network system according to a sixth example of the present disclosure. The network system includes at least one switch 720 provided by the fourth example or the fifth example. The switch 720 may constitute a two-layer or more than two-layer switching network, where each switch is only connected with a switch in an upper layer or a switch in a lower layer.

The numbering of the above-described examples is only for description, but not represents any advantages or disadvantages of the examples.

Those skilled in the art may understand that the modules in the apparatus example may be distributed in the apparatus of the example according to the descriptions, or may change correspondingly to locate in one or more apparatuses different from the example. The modules in above example may be merged into one module, or may be divided into multiple sub-modules furthermore.

Those skilled in the art may understand that all or part of steps in the above-described examples may be implemented by hardware, or by programs instructing related hardware. The programs may be stored in a computer-readable storage medium, such as Read-Only Memory (ROM), magnetic disk, or optical disk. Optionally, it may download program codes from a server computer through a communication network. In addition, a system or apparatus configured with a storage medium can be provided, where software program codes for implementing functions of any of the aforementioned examples are stored in this storage medium, and it can make a computer (or Central Processing Unit (CPU) or Microprocessor Unit (MPU)) of the system or apparatus read out and perform the program codes stored in the storage medium.

In this case, the program codes read from the storage medium itself can implement the functions of any of the aforementioned embodiments. Therefore, the program codes and the storage medium storing the program codes form a part of the above-described route updating solution.

Further, it should be apparent that, part or all of the practical operations can be achieved not only by executing the program codes read by the computer, but also by an operation system operated by the computer through the instructions of the program codes, so that functions of any of examples in the above-described example are achieved.

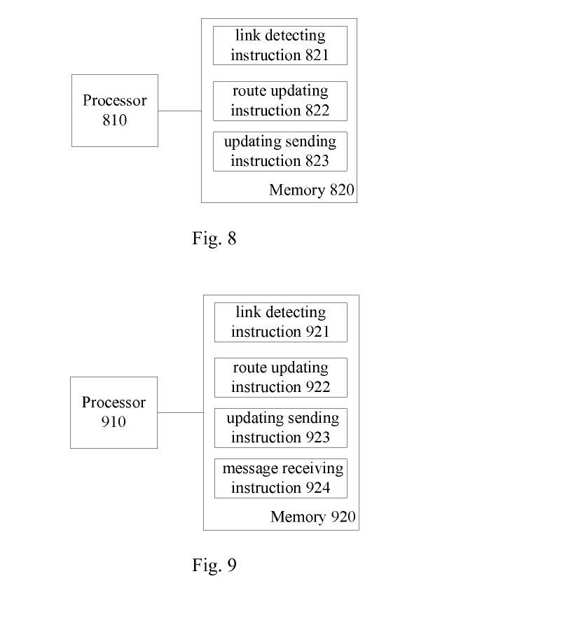

For example, FIG. 8 and FIG. 9 provide other structures of a switch according to an example of the present disclosure.

### Example 7

FIG. 8 is a schematic diagram illustrating a structure of a switch according to a seventh example of the present disclosure. The switch includes a memory 820, and a processor 810 in communication with memory 820. Memory 820 may store the following instructions executable by processor 810, which are a link detecting instruction 821, a route updating instruction 822 and an updating sending instruction 823.

The link detecting instruction 821 indicates to detect link states of at least two neighbor devices, where the neighbor device is an upstream device or a downstream device which is reachable by the current device through one hop.

The route updating instruction 822 indicates to, when detecting that the link state of a first neighbor device is unreachable by executing the link detecting instruction 821, set a state of a routing item with an initial state being reachable among all routing items corresponding to the first neighbor device in an internal routing table to be unreachable.

The updating sending instruction 823 indicates to, after a state of at least one routing item is set to be unreachable by executing the route updating instruction 822 due to the link state being changed, detect whether the states of all routing items corresponding to each target subnet in the internal routing table are all unreachable, respectively; when detecting that the states of all routing items corresponding to one target subnet are all unreachable, send a route updating message to another neighbor device except the first neighbor device, so that another neighbor device sets the state of the routing item corresponding to both the current device and the target subnet in an internal routing table to be unreachable.

### Example 8

FIG. 9 is a schematic diagram illustrating a structure of a switch according to an eighth example of the present disclosure. The switch includes a memory 920, and a processor 910 in communication with memory 920. Memory 920 may store the following instructions executable by processor 910, which are a link detecting instruction 921, a route updating instruction 922, an updating sending instruction 923 and a message receiving instruction 924. In addition, memory 920 further stores an internal routing table.

In the internal routing table, each routing item is identified by a two-dimensional coordinate in the internal routing table of the current device, where one coordinate in the two-dimensional coordinate represents a neighbor device, and the other represents a target subnet; for each routing item, when a path across a neighbor device corresponding to the coordinate of the routing item to a target subnet corresponding to the other coordinate of the routing item is not a shortest path among all the paths for the current device to the target subnet, the state of the routing item is always unreachable.

The link detecting instruction 921 indicates to detect link states of at least two neighbor devices, where the neighbor device is an upstream device or a downstream device which is reachable by the current device through one hop.

The route updating instruction 922 indicates to, when detecting that the link state of a first neighbor device is unreachable by executing the link detecting instruction 921, set a state of a routing item with an initial state being reachable among all routing items corresponding to the first neighbor device in an internal routing table to be unreachable.

The updating sending instruction 923 indicates to, after a state of at least one routing item is set to be unreachable by executing the route updating instruction 922 due to the link state being changed, detect whether the states of all routing items corresponding to each target subnet in the internal routing table are all unreachable, respectively; when detecting that the states of all routing items corresponding to one target subnet are all unreachable, send a route updating message to another neighbor device except the first neighbor device, so that another neighbor device sets the state of the routing item corresponding to both the current device and the target subnet in an internal routing table to be unreachable.

The route updating instruction 922 further indicates to, when detecting the link state of the first neighbor device is changed from unreachable to reachable by executing the link detecting instruction 921, resume a state of a routing item with an initial state being reachable among all routing items corresponding to the first neighbor device in the internal routing table from unreachable to reachable.

The updating sending instruction 923 further indicates to, after a state of at least one routing item is resumed to be reachable by executing the route updating instruction 922 due to the link state being changed, detect whether the states of all the routing items corresponding to each target subnet in the internal routing table are changed from always unreachable to at least one reachable; when detecting that the states of all the routing items corresponding to one target subnet are changed from always unreachable to at least one reachable, send a route updating message to another neighbor device except the first neighbor device, so that another neighbor device resumes the state of the routing item corresponding to both the current device and the target subnet in an internal routing table from unreachable to reachable.

The message receiving instruction 924 indicates to receive a route updating message from a second neighbor device; where the route updating message carries an identifier of the second neighbor device, an identifier of the target subnet and an identifier of whether the state is reachable.

The route updating instruction 922 further indicates to, update the state of the routing item corresponding to both the second neighbor device and the target subnet in the internal routing table according to the identifier of whether the state is reachable by executing the message receiving instruction 924; the updating includes changing the state of the routing item from reachable to unreachable, or resuming from unreachable to reachable.

The updating sending instruction 923 further indicates to, after a state of at least one routing item is set to be unreachable by executing the route updating instruction 922 due to the route updating, detect whether the states of all routing items corresponding to each target subnet in the internal routing table are all unreachable, respectively; when detecting that the states of all routing items corresponding to one target subnet are all unreachable, send a route updating message to another neighbor device except the second neighbor device, so that another neighbor device sets the state of the routing item corresponding to both the current device and the target subnet in an internal routing table to be unreachable.

And/or, the updating sending instruction 923 further indicates to, after a state of at least one routing item is resumed to be reachable by executing the route updating instruction 922 due to route updating, detect whether the states of all the routing items corresponding to each target subnet in the internal routing table are changed from always unreachable to at least one reachable; when detecting that the states of all the routing items corresponding to one target subnet are changed from always unreachable to at least one reachable, send a route updating message to another neighbor device except the second neighbor device, so that another neighbor device resumes the state of the routing item corresponding to both the current device and the target subnet in an internal routing table from unreachable to reachable.

The updating sending instruction 923 further indicates to send a route updating message to another neighbor device with respect to a same routing item in a time interval which is not lower than a predetermined threshold.

The foregoing is preferred examples of the present disclosure, which is not used for limiting the protection scope of the present disclosure. Any modifications, equivalent substitutions and improvements made within the spirit and principle of the present disclosure, should be covered by the protection scope of the present disclosure.

1-12. (canceled)

13. A method for updating a route, comprising:
detecting, by a current device, link states of at least two neighbor devices, the neighbor device being an upstream device or a downstream device of the current device reachable through one hop;
when the current device detects that a link state of a first neighbor device is unreachable, setting, by the current device, a state of a routing item with an initial state being reachable among all routing items corresponding to the first neighbor device in an internal routing table to be unreachable; and
after the current device sets a state of at least one routing item to be unreachable due to the link state being changed, detecting, by the current device, whether states of all routing items corresponding to each target subnet in the internal routing table are all unreachable, respectively; when detecting that states of all routing items corresponding to one target subnet are all unreachable, sending a route updating message to another neighbor device except the first neighbor device, so that the another neighbor device sets a state of a routing item corresponding to both the current device and the target subnet in the internal routing table to be unreachable.

14. The method of claim 1, wherein before detecting link states of at least two neighbor devices, further comprising:
storing, by the current device, the internal routing table, wherein each routing item is identified by a two-dimensional coordinate in the internal routing table, one coordinate in the two-dimensional coordinate represents a neighbor device, and the other coordinate represents a target subnet; for each routing item, when a path across a neighbor device corresponding to the coordinate of the routing item to the target subnet corresponding to the other coordinate of the routing item is not a shortest path among all paths for the current device to the target subnet, setting the state of the routing item to be always unreachable.

15. The method of claim 13, further comprising:
when the current device detects that a link state of the first neighbor device is changed from unreachable to reachable, resuming, by the current device, a state of a routing item with an initial state being reachable among all routing items corresponding to the first neighbor device in the internal routing table from unreachable to reachable;
after the current device resumes a state of at least one routing item to be reachable due to the link state being changed, detecting, by the current device, whether states of all routing items corresponding to each target subnet in the internal routing table are changed from always unreachable to at least one reachable; when detecting that the states of all routing items corresponding to one target subnet are changed from always unreachable to at least one reachable, sending a route updating message to another neighbor device except the first neighbor device, so that the another neighbor device resumes a state of the routing item corresponding to both the current device and the target subnet in an internal routing table from unreachable to reachable.

16. The method of claim 14, further comprising:
when the current device detects that a link state of the first neighbor device is changed from unreachable to reachable, resuming, by the current device, a state of a routing item with an initial state being reachable among all routing items corresponding to the first neighbor device in the internal routing table from unreachable to reachable;
after the current device resumes a state of at least one routing item to be reachable due to the link state being changed, detecting, by the current device, whether states of all routing items corresponding to each target subnet in the internal routing table are changed from always unreachable to at least one reachable; when detecting that the states of all routing items corresponding to one target subnet are changed from always unreachable to at least one reachable, sending a route updating message to another neighbor device except the first neighbor device, so that the another neighbor device resumes a state of the routing item corresponding to both the current device and the target subnet in an internal routing table from unreachable to reachable.

17. The method of claim 13, further comprising:
receiving, by the current device, a route updating message from a second neighbor device; wherein the route updating message carries an identifier of the second neighbor device, an identifier of a target subnet and an identifier of whether a state is reachable;
updating, by the current device, the state of the routing item corresponding to both the second neighbor device and the target subnet in the internal routing table according to the identifier of whether the state is reachable; wherein the updating comprises changing the state of the routing item from reachable to unreachable, or resuming from unreachable to reachable;
after the current device sets a state of at least one routing item to be unreachable due to route updating, detecting, by the current device, whether states of all routing items corresponding to each target subnet in the internal routing table are all unreachable, respectively; when detecting that states of all routing items corresponding to one target subnet are all unreachable, sending a route updating message to another neighbor device except the second neighbor device, so that the another neighbor device sets the state of the routing item corresponding to both the current device and the target subnet in an internal routing table to be unreachable; and/or,
after the current device resumes a state of at least one routing item to be reachable due to route updating, detecting, by the current device, whether states of all routing items corresponding to each target subnet in the internal routing table are changed from always unreachable to at least one reachable; when detecting that states of all routing items corresponding to one target subnet are changed from always unreachable to at least one reachable, sending a route updating message to another neighbor device except the second neighbor device, so that the another neighbor device resumes the state of the routing item corresponding to both the current device and the target subnet in an internal routing table from unreachable to reachable.

18. The method of claim 14, further comprising:
receiving, by the current device, a route updating message from a second neighbor device; wherein the route updating message carries an identifier of the second neighbor device, an identifier of a target subnet and an identifier of whether a state is reachable;
updating, by the current device, the state of the routing item corresponding to both the second neighbor device and the target subnet in the internal routing table according to the identifier of whether the state is reachable; wherein the updating comprises changing the state of the routing item from reachable to unreachable, or resuming from unreachable to reachable;
after the current device sets a state of at least one routing item to be unreachable due to route updating, detecting, by the current device, whether states of all routing items corresponding to each target subnet in the internal routing table are all unreachable, respectively; when detecting that states of all routing items corresponding to one target subnet are all unreachable, sending a route updating message to another neighbor device except the second neighbor device, so that the another neighbor device sets the state of the routing item corresponding to both the current device and the target subnet in an internal routing table to be unreachable; and/or,
after the current device resumes a state of at least one routing item to be reachable due to route updating, detecting, by the current device, whether states of all routing items corresponding to each target subnet in the internal routing table are changed from always unreachable to at least one reachable; when detecting that states of all routing items corresponding to one target subnet are changed from always unreachable to at least one reachable, sending a route updating message to another neighbor device except the second neighbor device, so that the another neighbor device resumes the state of the routing item corresponding to both the current device and the target subnet in an internal routing table from unreachable to reachable.

19. The method of claim 17, further comprising:
sending, by the current device, a route updating message to another neighbor device with respect to a same routing item in a time interval which is not lower than a predetermined threshold.

20. A switch, comprising:
a link detecting module, configured to detect link states of at least two neighbor devices, the neighbor device being an upstream device or a downstream device of the switch reachable through one hop;
a route updating module, configured to, when the link detecting module detects that a link state of a first neighbor device is unreachable, set a state of a routing item with an initial state being reachable among all routing items corresponding to the first neighbor device in an internal routing table to be unreachable; and
an updating sending module, configured to, after a state of at least one routing item is set to be unreachable due to the link state being changed, detect whether states of all routing items corresponding to each target subnet in the internal routing table are all unreachable, respectively; when detecting that states of all routing items corresponding to one target subnet are all unreachable, send a route updating message to another neighbor device except the first neighbor device, so that another neighbor device sets a state of a routing item corresponding to both the current device and the target subnet in an internal routing table to be unreachable.

21. The switch of claim 20, further comprising:
a routing table storing module, configured to store the internal routing table, wherein each routing item is identified by a two-dimensional coordinate in the internal routing table, one coordinate in the two-dimensional coordinate represents a neighbor device, and the other coordinate represents a target subnet; for each routing item, when a path across a neighbor device corresponding to the coordinate of the routing item to a target subnet corresponding to the other coordinate of the routing item is not a shortest path among all paths for the current device to the target subnet, set the state of the routing item to be always unreachable.

22. The switch of claim 20, wherein
the route updating module is further configured to, when the link detecting module detects that a link state of the first neighbor device is changed from unreachable to reachable, resume a state of a routing item with an initial state being reachable among all routing items corresponding to the first neighbor device in the internal routing table from unreachable to reachable;
the updating sending module is further configured to, after the current device resumes a state of at least one routing item to be reachable due to the link state being changed, detecting, by the current device, whether states of all routing items corresponding to each target subnet in the internal routing table are changed from always unreachable to at least one reachable; when detecting that the states of all routing items corresponding to one target subnet are changed from always unreachable to at least one reachable, sending a route updating message to another neighbor device except the first neighbor device, so that the another neighbor device resumes a state of the routing item corresponding to both the current device and the target subnet in an internal routing table from unreachable to reachable.

23. The switch of claim 20, wherein
the route updating module is further configured to, when the link detecting module detects that a link state of the first neighbor device is changed from unreachable to reachable, resume a state of a routing item with an initial state being reachable among all routing items corresponding to the first neighbor device in the internal routing table from unreachable to reachable;
the updating sending module is further configured to, after the current device resumes a state of at least one routing item to be reachable due to the link state being changed, detecting, by the current device, whether states of all routing items corresponding to each target subnet in the internal routing table are changed from always unreachable to at least one reachable; when detecting that the states of all routing items corresponding to one target subnet are changed from always unreachable to at least one reachable, sending a route updating message to another neighbor device except the first neighbor device, so that the another neighbor device resumes a state of the routing item corresponding to both the current device and the target subnet in an internal routing table from unreachable to reachable.

24. The switch of claim 20, further comprising:
a message receiving module, configured to, receive a route updating message from a second neighbor device; wherein the route updating message carries an identifier of the second neighbor device, an identifier of a target subnet and an identifier of whether a state is reachable;
wherein the route updating module is further configured to, update the state of the routing item corresponding to both the second neighbor device and the target subnet in the internal routing table according to the identifier of whether the state is reachable; wherein the updating comprises changing the state of the routing item from reachable to unreachable, or resuming from unreachable to reachable;
the updating sending module is further configured to, after a state of at least one routing item is set to be unreachable due to route updating, detect whether states of all routing items corresponding to each target subnet in the internal routing table are all unreachable, respectively; when detecting that states of all routing items corresponding to one target subnet are all unreachable, send a route updating message to another neighbor device except the second neighbor device, so that the another neighbor device sets the state of the routing item corresponding to both the current device and the target subnet in an internal routing table to be unreachable; and/or,
the updating sending module is further configured to, after a state of at least one routing item is resumed to be reachable due to route updating, detect whether states of all routing items corresponding to each target subnet in the internal routing table are changed from always unreachable to at least one reachable; when detecting that states of all routing items corresponding to one target subnet are changed from always unreachable to at least one reachable, send a route updating message to another neighbor device except the second neighbor device, so that the another neighbor device resumes the state of the routing item corresponding to both the current device and the target subnet in an internal routing table from unreachable to reachable.

25. The switch of claim 24, further comprising:
a message receiving module, configured to, receive a route updating message from a second neighbor device; wherein the route updating message carries an identifier of the second neighbor device, an identifier of a target subnet and an identifier of whether a state is reachable;
wherein the route updating module is further configured to, update the state of the routing item corresponding to both the second neighbor device and the target subnet in the internal routing table according to the identifier of whether the state is reachable; wherein the updating comprises changing the state of the routing item from reachable to unreachable, or resuming from unreachable to reachable;
the updating sending module is further configured to, after a state of at least one routing item is set to be unreachable due to route updating, detect whether states of all routing items corresponding to each target subnet in the internal routing table are all unreachable, respectively; when detecting that states of all routing items corresponding to one target subnet are all unreachable, send a route updating message to another neighbor device except the second neighbor device, so that the another neighbor device sets the state of the routing item corresponding to both the current device and the target subnet in an internal routing table to be unreachable; and/or,
the updating sending module is further configured to, after a state of at least one routing item is resumed to be reachable due to route updating, detect whether states of all routing items corresponding to each target subnet in the internal routing table are changed from always unreachable to at least one reachable; when detecting that states of all routing items corresponding to one target subnet are changed from always unreachable to at least one reachable, send a route updating message to another neighbor device except the second neighbor device, so that the another neighbor device resumes the state of the routing item corresponding to both the current device and the target subnet in an internal routing table from unreachable to reachable.

26. The switch of claim 24, wherein
the updating sending module is further configured to, send a route updating message to another neighbor device with respect to a same routing item in a time interval which is not lower than a predetermined threshold.

27. A switch, comprising a processor and a memory communicated with the processor; in the memory, the instructions that are executed by the processor are stored, comprising:
a link detecting instruction, to detect link states of at least two neighbor devices, the neighbor device being an upstream device or a downstream device of the switch reachable through one hop;
a route updating instruction, to when detecting that a link state of a first neighbor device is unreachable by executing the link detecting instruction, set a state of a routing item with an initial state being reachable among all routing items corresponding to the first neighbor device in an internal routing table to be unreachable; and
an updating sending instruction, to after a state of at least one routing item is set to be unreachable due to the link state being changed, detect whether states of all routing items corresponding to each target subnet in the internal routing table are all unreachable, respectively; when detecting that states of all routing items corresponding to one target subnet are all unreachable, send a route updating message to another neighbor device except the first neighbor device, so that another neighbor device sets a state of a routing item corresponding to both the current device and the target subnet in an internal routing table to be unreachable.
